(19) United States
(12) Patent Application Publication
(10) Pub. No.: US 2008/0064798 A1
(43) Pub. Date: Mar. 13, 2008

(54) Novel method for nanoclay particle dispersion

(76) Inventor: David Abecassis, Huntington, NY (US)

Correspondence Address: Attn: Thomas A. O'Rourke;Bodner & O'Rourke, 425 Broadhollow Road, Melville, NY, 11747, US

(21) Appl. No.: 11/880,888

(22) Filed: Jul. 23, 2007

Related U.S. Application Data
(63) Continuation-in-part of application No. 11/645,093, filed on Dec. 22, 2006.
(60) Provisional application No. 60/832,337, filed on Jul. 21, 2006.

(51) Int. Cl. C08K 3/32

(52) U.S. Cl. 524/132

(57) ABSTRACT

Nanocomposite thermoplastic blends are disclosed made from a thermoplastic resin, an organoclay and a diphosphate. There blends so formed have superior properties compared to blends of a thermoplastic, an organoclay and a maleic anhydride graft copolymer.

This application claims priority on U.S. Provisional Patent Application Ser. No. 60/832,337 filed Jul. 21, 2006. This application is a continuation in part of U.S. application Ser. No. 11/645,093 filed Dec. 22, 2006, the disclosures of which are incorporated herein by reference.

### FIELD OF THE INVENTION

The present invention is directed to improved nanocomposite thermoplastics and in particular to the use of a boosting additive technology for higher quaternary amine organoclay exfoliation.

### BACKGROUND OF THE INVENTION

Thermoplastic nanocomposites made from quaternary amine treated organoclays have unusual properties due to the interaction of the high surface area of the clay with the polymer matrix. Relatively small loading rates of quaternary treated organoclays in a thermoplastic have significant transformative effects on thermoplastics; especially in flexural modulus, UV, barrier, thermal and chemical resistance. The optimal scenario for an organoclay nanocomposite is to have full exfoliation thereby improving such properties as barrier, mechanical, and UV resistance. These properties are typically a function of the degree of exfoliation of the clay crystals.

Exfoliation occurs when the clay crystals separate out individually and disperse in the polymer matrix. In this respect, adjunct fillers such as maleic anhydride grafted polymers can be added in with the additive filler package along with the organoclay to boost exfoliation rates. Maleic anhydride is frequently used as a compatibilizer because it improves the rate of exfoliation of an organoclay in a thermoplastic, but it is a fairly expensive material to use. There are several polymer varieties of grafted maleic anhydride polymers, and all have the property of interfacing with the individual clay crystals' surfaces and stabilizing their exfoliation and thus their separation.

Maleic anhydride grafted polymers are also added to thermoplastic organoclay blends as impact modifiers and into other plastics to add toughness. Maleic anhydride grafted polymers can also be used to disperse high value particles such as flame retardants in the polymer matrix. Maleic anhydride grafted polymers are used as a compatiblizer and dispersant in a wide variety of thermoplastic polymer systems. However, maleic anhydride is in its pure form; highly toxic, which is why it is chemically bonded, i.e. grafted, to a backbone polymer prior to use in thermoplastics.

### SUMMARY OF THE INVENTION

The present invention is directed towards the use of organic diphosphates as a quaternary amine organoclay exfoliation boosting agent. The use of a diphosphate provides superior exfoliation of the organoclay and eliminates the need for the use of a maleic anhydride grafted copolymer as a copatibilizer. The diphosphates of the present invention are preferably resorcinol diphosphate(RDP) and bis-phenol diphosphate(BDP) but others may be used as well. Blends of resorcinol diphosphate(RDP) and bis-phenol diphosphate(BDP) may be used as well. The preferred quaternary amine treated clays are the Wyoming Bentonite variety of swelling bentonite and similar clays, and hectorite, which is a swelling magnesium-lithium silicate clay, as well as synthetically prepared smectite-type clays such as montmorillonite, bentonite, beidelite, hectorite saponite, and stevensite.

The organic phosphates are liquid at room temperature and can be blended mechanically in directly with the clay in dry form. The clay behaves like a fluid under high shear, and the liquid organophosphates can be added in using liquid or dry powder processing equipment. Liquid processing equipment would be any liquid mixing device; static or active, where the organoclay flows well enough to be processed. Dry mixing equipment would be any processing equipment such as powder or cement mixing equipment.

The organophosphate can be added prior to or during the processing operation. It can be metered in doses for master batch and semi-master batch manufacturing, or sprayed or fed into the clay via tubing for continuous manufacturing.

It has been found that very small amounts of RDP/and or BDP can have noticeable effects on the mechanical properties of nanocomposite thermoplastic polymers. Initial results of thermoplastic nanocomposites measured with DMA showed that there were significant improvements in mechanical properties achieved using the diphosphates to increase exfoliation of the organoclay in the thermoplastic material. Thus, the additional exfoliation of quaternary amine treated organoclays (10-30% or more improvement) could be achieved with as little as one half of one percent (0.5%) by weight RDP or BDP or blends thereof in the nanocomposite thermoplastic. To achieve the same improvement using maleic anhydride-grafted polymer (MAGP) as much as 10% weight MAGP/weight nanocomposite plastic would be used. In addition MAGP is expensive compared to the diphosphates of the present invention. Similarly, to achieve the same exfoliation rate as achieved using MAGP, less diphosphate is needed to achieve the same results.

### DETAILED DESCRIPTION OF THE INVENTION

The clays used in the present invention are preferably quaternary amine treated organoclays of the sodium smectite variety. A smectite is a naturally occurring clay mineral selected from a group including hectorite, montmorillonite, bentonite, beidelite, saponite, stevensite and mixtures thereof. A particularly preferred choice for the smectite is montmorillonite.

The chemical organic component preferred bound to the clay are preferably quaternary amine salts of benzyl hydrogenated tallow, bis-dimethyl ammonium, and alkyl ammonium.

The quaternary amine treated organoclay is mixed with preferred loading rates of the RDP and/or BDP or blends thereof, of 0.5% by weight up to about 50% by weight. The organoclay is present in the blend in an amount of about 1% by weight to about 50% by weight. More preferably the diphosphate is present in an amount up to about 20% by weight and the organoclay is present up to about 20% by weight. The balance of the thermoplastic nanocomposite is a thermoplastic resin. In some compositions where RDP/ and or BDP is higher than 1-3% of the entire final material by weight, or more, the RDP/ and or BDP may begin to act as a plasticizer. This is not always desirable for all applications. In these applications where the diphosphate is not to be used as a plasticizer, only up to about 3% by weight of the diphosphate should be used.

The composition of the present invention can be formed, for example, by melt mixing using, for example, a co-rotating intermeshing twin screw extruder. Other means of forming the blend can be used as well. The blends of the present invention exhibit dramatic improvements in mechanical properties, thermal resistance and gas barrier properties as compared to other organoclay/thermoplastic blends.

In the blends of the present invention, there is a thermoplastic material. The thermoplastic material can include a polyolefin such as polyethylene, or polypropylene and the like, ethylene vinyl acetate copolymer, polycarbonates, polyurethanes, polysiloxanes, polymethacrylates, polyacrylates, polyarylates, polyvinyls, polyethers, polyamides, polyesters and blends thereof.

The thermoplastic material may be present in the composition in a range of about 1% by weight to about 98.5% by weight.

To formulate the nanocomposites of the present invention an organoclay is added to the thermoplastic resin. The organoclay can initially be preblended with a diphosphate or the diphosphate can be added to the organoclay thermoplastic blend. The diphosphate is preferably RDP or BDP. The organoclay is preferably present in the blend in an amount of 1% by weight to about 20% by weight. The diphosphate is present in an amount of from 0.05% by weight to about 20% be weight.

The diphosphates are used as a compatibilizer to facilitate exfoliation of the organoclay. In a preferred embodiment, when the diphosphate is used as a compatibilizer there is no maleic anhydride present as a compatibilizer. It has been found that blends of a thermoplastic and an organoclay that have a diphosphate present as a compatibilizer instead of maleic anhydride grafted copolymers have superior properties when compared to blends having the same composition but where the diphosphate replaces the maleic anhydride grafted copolymer used as a compatibilizer.

For example, when measuring the flexular modulus value using dynamic mechanical analysis, replacing the maleic anhydride grafted copolymer with a diphosphate increases the flexular modulus, i.e., the flexular strength, by at least 10% as measured by ASTMD 790 compared to the same blend with maleic anhydride graft copolymer present instead. In some cases where quaternary amine treated organoclays act as plasticizers; as does Cloisite 20A with HIPS (High Impact Polystyrene), then amplifying exfoliation of the quaternary amine treated organoclay does not benefit the flexural modulus of the thermoplastic nanocomposite. Increased exfoliation of the clay using the diphosphates is still achieved, however.

Resorcinol diphosphate (RDP) and/or Bis-phenol diphosphate(BDP) may be used as an additive combined with a quaternary amine treated organoclay to thereby boost clay platelet exfoliation in thermoplastic nanocomposites, as measured by dynamic mechanical analysis (DMA) and visualized by transmission electron microscope. The RDP and or BDP may be added to the dry clay post clay manufacture.(downstream addition) Alternatively, the RDP and or BDP can be added to the quaternary ammonium salt addition phase during organic treatment of the clay (process addition). Also, the RDP and or BDP can be added to the quaternary amine prior to quaternary amine organoclay manufacturing.(upstream addition).

1. A nanocomposite thermoplastic blend comprising a thermoplastic resin, an organoclay and a diphosphate.

2. The blend according to claim 1, wherein said diphosphate is resorcinol diphosphate.

3. The blend according to claim 1, wherein said diphosphate is bis-phenol diphosphate.

4. The blend according to claim 2, wherein the resorcinol diphosphate is present in a range of about 0.005% to about 20% by weight.

5. The blend according to claim 4, wherein the organoclay is present in a range of about 1 to about 20% by weight or organoclay.

6. The blend according to claim 5, wherein said thermoplastic is present in an amount of up to about 98.995% by weight.

7. The blend according to claim 2, wherein the resorcinol diphosphate is present in an amount of 0.5% by weight to about 20% by weight.

8. The blend according to claim 7, wherein said organoclay is present in a range of about 1% to about 3% by weight.

9. The blend according to claim 8, wherein said thermoplastic is present in an amount of up to about 98.5% by weight.

10. The blend according to claim 3, wherein the resorcinol diphosphate is present in a range of about 0.5% to about 20% by weight.

11. The blend according to claim 10, wherein the organoclay is present in a range of about 1 to about 20% by weight or organoclay.

12. The blend according to claim 11, wherein said thermoplastic is present in an amount of up to about 98.5% by weight.

13. The blend according to claim 3, wherein the resorcinol diphosphate is present in an amount of 0.5% by weight to about 20% by weight.

14. The blend according to claim 13, wherein said organoclay is present in a range of about 1% to about 3% by weight.

15. The blend according to claim 14, wherein said thermoplastic is present in an amount of up to about 98.5% by weight.

16. The blend according to claim 2, wherein the blend has a flexular modulus at least 10% higher according to ASTMD 790 than the flexular modulus of same blend where maleic anhydride copolymer is used as a compatibilizer instead of the resorcinol diphosphate.

17. The blend according to claim 3, wherein the blend has a flexular modulus at least 10% higher according to ASTMD 790 than the flexular modulus of same blend where maleic anhydride copolymer is used as a compatibilizer instead of the bis-phenol diphosphate.

18. A method of increasing the exfoliation of a organoclay in the thermoplastic material comprising forming a blend of a thermoplastic resin, an organoclay and a diphosphate.

19. The method according to claim 1, wherein said diphosphate is resorcinol diphosphate.

20. The method according to claim 1, wherein said diphosphate is bis-phenol diphosphate.
